(19) United States
(12) Patent Application Publication
(10) Pub. No.: US 2015/0019551 A1
(43) Pub. Date: Jan. 15, 2015

(54) REGION CLASSIFICATION BASED ON REGIONAL DISTRIBUTION INFORMATION

(71) Applicants: Sharvil Nanavati, Dundas (CA); Casey Kwok Ching Ho, San Jose, CA (US); Steven Gregory Woods, Mannheim (CA)

(72) Inventors: Sharvil Nanavati, Dundas (CA); Casey Kwok Ching Ho, San Jose, CA (US); Steven Gregory Woods, Mannheim (CA)

(73) Assignee: GOOGLE INC., Mountain View, CA (US)

(21) Appl. No.: 13/271,532

(22) Filed: Oct. 12, 2011

(51) Int. Cl. G06F 17/30

(52) U.S. Cl. 707/737; 707/E17.009

(57) ABSTRACT

A region classification server classifies a region based on region distribution information. The region classification server may include several databases to facilitate the classification of the region, including a classification type database, a classification evaluation database, and a region classification database. The region classification server may also include one or more interfaces for receiving region distribution information, such as an automated business listing interface and a user-input classification interface. The region classification server may also classify a region by modifying a classification evaluation stored in the classification evaluation database, where the modification is based on received user information. Moreover, the region classification server may provide the region classifications to other systems in communication with the region classification server, such as search engine providers, augmented reality developers, or other third-party entities.

### BACKGROUND

When a person visits a region, such as a city, town, neighborhood, etc., there are usually points of interest the person may be interested in visiting. However, a user may not know enough about a particular region to know where those points of interest are located within the region or to even know how to query a computer system to identify those points of interest.

### BRIEF SUMMARY

An apparatus for classifying a region based on distribution information is disclosed. In one embodiment, the apparatus includes a memory operative to store a plurality of associations between a plurality of classification types and a plurality of classification values for the region, wherein each classification type is associated with at least one classification value and a plurality of classification evaluations for assigning a classification to the region, wherein each classification evaluation is associated with a classification type. The memory may also be operative to store at least one region assignment, wherein the at least one region assignment comprises a classification value assigned to the region.

The apparatus may also include a processor in communication with the memory, the processor being operative to receive regional distribution data for the region, determine at least one classification type selected from the plurality of classification types based on the received regional distribution data, and determine at least one classification value for the at least one classification type based on the regional distribution data. The processor may be further operative to determine at least one classification evaluation for the region based on the at least one classification type, determine a classification value for the at least one region assignment based on the at least one classification evaluation and the at least one classification value, and store the at least one region assignment for the region in the region classification database, wherein the at least one region assignment comprises the at least one determined classification value assigned to the region.

In another embodiment of the apparatus, the region is defined by a plurality of coordinates.

In a further embodiment of the apparatus, the region is identified according to a postal address identifier.

In yet another embodiment of the apparatus, the at least one classification evaluation comprises a threshold and the processor determines the classification value for the at least one region assignment when the at least one classification value for the at least one classification type obtained from the region distribution data exceeds the threshold.

In yet a further embodiment of the apparatus, the at least one classification evaluation comprises a first threshold associated with a first classification value and a second threshold associated with a second classification value, and the processor is further operative to determine the classification value for the at least one region assignment based on the relationship between the first classification value and the first threshold and the second classification value and the second threshold.

In another embodiment of the apparatus, the classification value for the at least one region assignment is associated with a first classification type, and the processor is further operative to determine a second classification value for a second region assignment based on the evaluation of at least a second classification value associated with a second classification type and evaluated by a second classification valuation, the first classification type and the second classification type being different types of classifications.

In a further embodiment of the apparatus, the apparatus further comprises an automated business listing information interface operative to receive a plurality of business listings located in the region, the received regional distribution data comprises the plurality of received business listings, and the processor determines, for each of the plurality of business listings, the classification type selected from the plurality of classification types based on a business type associated with each of the plurality of business listings.

In yet another embodiment of the apparatus, the apparatus further comprises a user-input classification interface operative to receive a region assignment from a user, and the processor is further operative to store the received region assignment from the user in the region classification database.

In yet a further embodiment of the apparatus, the apparatus further comprises a user-input information interface operative to receive user information, and the processor is further operative to modify the at least one classification evaluation based on the received user information.

In another embodiment of the apparatus, the apparatus further comprises a region classification request interface, and the processor is further operative to receive a request from a requesting entity for a region assignment from the region classification request interface, wherein the region assignment selected from the plurality of region assignments. The processor may be further operative to format a response to the request based on the type of requesting entity, wherein the requested region assignment is modified based on the type of requesting entity, and the processor may transmit the formatted response to the requesting entity.

A method for classifying a region based on distribution information is also disclosed. In one embodiment, the method includes establishing, in a memory, a plurality of associations between a plurality of classification types and a plurality of classification values, wherein each classification type is associated with at least one classification value, establishing a plurality of classification evaluations for assigning a classification to the region, and establishing a plurality of region assignments, wherein each region assignment comprises at least one classification value assigned to a region.

The method may also include receiving, with a processor in communication with the memory, regional distribution data for the region, determining at least one classification type selected from the plurality of classification types based on the received regional distribution data, determining at least one classification value for the at least one classification type based on the regional distribution data, determining at least one classification evaluation for the region based on the at least one classification type, determining at least one classification value for the at least one region assignment based on the at least one classification evaluation and the at least one classification value, and storing the at least one region assignment for the region in the region classification database, wherein the region assignment comprises the determined at least one classification value assigned to the region.

In another embodiment of the method, the region is defined by a plurality of coordinates.

In a further embodiment of the method, the region is identified according to a postal address identifier.

In yet another embodiment of the method, the at least one classification evaluation comprises a threshold and the method further comprises determining the classification value for the at least one region assignment when the at least one classification value for the at least one classification type obtained from the region distribution data exceeds the threshold.

In yet a further embodiment of the method, the at least one classification evaluation comprises a first threshold associated with a first classification value and a second threshold associated with a second classification value, and the method further includes determining the classification value for the at least one region assignment based on the relationship between the first classification value and the first threshold and the second classification value and the second threshold.

In another embodiment of the method, the classification value for the at least one region assignment is associated with a first classification type, and the method further comprises determining a second classification value for a second region assignment based on the evaluation of at least a second classification value associated with a second classification type and evaluated by a second classification evaluation, the first classification type and the second classification type being different types of classifications.

In a further embodiment of the method, the method includes receiving a plurality of business listings located in the region, wherein the received regional distribution data comprises the plurality of business listings, and determining, for each of the plurality of business listings, the classification type selected from the plurality of classification types based on a business type associated with each of the plurality of business listings.

In yet another embodiment of the method, the method includes receiving a region assignment from a user, and storing the received region assignment from the user in the region classification database.

In yet a further embodiment of the method, the method further includes receiving user information, and modifying the at least one classification evaluation based on the received user information.

In another embodiment of the method, the method further includes receiving a request from a requesting entity for a region assignment from a region classification request interface, the region assignment selected from the plurality of region assignments, formatting a response to the request based on the type of requesting entity, wherein the requested region assignment is modified based on the type of requesting entity, and transmitting the formatted response to the requesting entity.

### BRIEF DESCRIPTION OF THE DRAWINGS

FIG. 1 illustrates one example of an apparatus for classifying a region according to aspects of the invention.

FIG. 2 illustrates one example of a region classification server according to aspects of the invention.

FIG. 3 illustrates one example of regions being classified according to aspects of the invention.

FIG. 4 illustrates one example of user-defined regions being classified according to aspects of the invention.

FIG. 5 illustrates one example of an overlapping region being classified according to aspects of the invention.

FIGS. 6A-6B illustrates one example of logic flow for assigning a classification to a region according to aspects of the invention.

### DETAILED DESCRIPTION

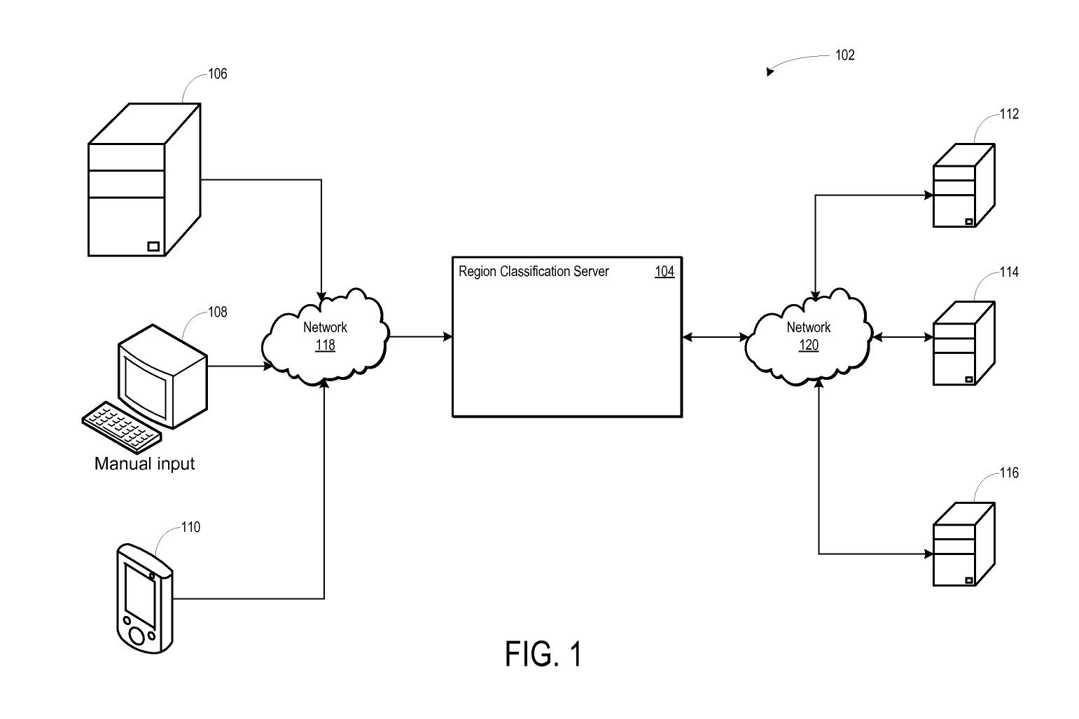

FIG. 1 illustrates one example of an apparatus 102 for classifying one or more regions and providing the classification of those regions to other systems. The apparatus 102 may include a region classification server 104 in communication with client devices 106-110 via a network 118 and in communication with systems 112-116 via a network 120.

The client devices 106-110 may provide different types of input to region classification server 104. For example, a server for a business listing provider 106 may provide business listings for businesses located in a region, a desktop computer 108 may provide user input manually classifying a region, and a mobile device 110 may be used to provide personal information about the user (user information).

Physically, client devices 106-110 may be any type of device, such as a laptop computer, a netbook, a tablet computer, an external system such as a server for a multiple listing service (“MLS”) or an Internet search provider, or any other type of client device now known or later developed.

As mentioned above, client device 106 may be operative to provide business listing information to the region classification server 104 for businesses located in a region. The business listing information may include the type or nature of a business, its postal address, the number of employees at the business, or other such information. In addition, the business information may include information specific to a particular type of business. For example, where the business is a restaurant, the business information may include the type of cuisine, the average cost of a meal, the hours of operation, the hours and durations of various meals (breakfast, lunch, dinner, etc.), or other such restaurant-specific information. As another example, where the business is an electronics retail merchant, the business information may include the type of electronic devices sold, whether the business is an authorized service dealer for a particular brand of devices, the average cost of a product sold by the business, or other such electronics retailer-specific information. Hence, the client device 106 may be operative to not only provide general business information, but also business information specific to particular types of business.

In addition to the business listing provider 106, region classification server 104 may more generally be in communication with other devices that provide other types of regional information. For example, region classification server 104 may be in communication with a multiple listing service operative to provide real estate listings for a region. A real estate listing may include the cost of a building (commercial, residential, industrial, etc.) for sale or lease, the square footage of the building, the number of rooms for the listing, and other such types of listing information. As another example, the region classification server 104 may be in communication with a government entity, such as the United States Census Bureau, and operative to receive regional information from the government entity. Using the U.S. Census Bureau as an example, the regional information may include the population distribution for the region, the per capita income distribution for the region, political party affiliation distribution for the region, or other such types of census information. In other words, the regional information provided to the region classification server 104 may be any type of information about a region that can be used to characterize the region.

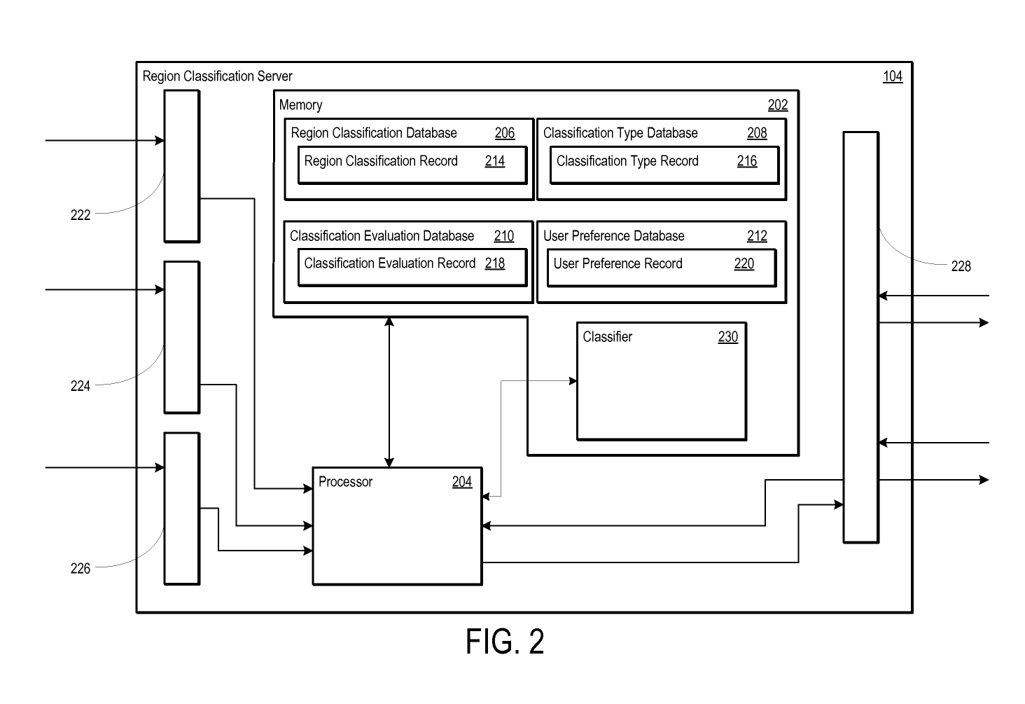

Region classification server 104 may also be operative to receive regional information from client device 108, which information may be manually provided by a user. For example, the user may provide information indicating that a selected region is affluent, has a predominant number of restaurants of a particular ethnicity, has a specified quality of a public school system, or other such information. The user may elect to provide his or her own classification for a region, as discussed below with reference to FIG. 2, or may alternatively provide information by selecting one or more classifications offered by region classification server 104.

Moreover, a user may manually define a region for classification. While the region classification server 104 may identify predefined regions, such as regions identified by postal address, town or city name, neighborhood name, etc., a user may manually define regions using a custom set of parameters. In one embodiment, the set of parameters may include a set of coordinates. Each coordinate may include a latitude and a longitude. As an example, a user may define a region within a triangle, such that the region is defined by three pairs of coordinates. In another embodiment, a user may define a region as a combination of regions. For example, a user may define a region as “The Greater New York City Area” to include the predefined region of New York City, N.Y. and a number of predefined regions of various suburbs in both New Jersey and New York. In yet another embodiment, a user may define a region using both a custom set of parameters and predefined regions. Moreover, the region classification server 104 may provide a region defined by a first user for classification by a second user. In this way, regions recognized and/or identified by the region classification server 104 may be updated or changed over time. Hence, the region classification server 104 is flexible such that it supports both predefined regions and user-defined regions for classification.

In addition to regional information, the region classification server 104 may also receive user information, which may be personal information. Such information can be provided, for example, via the client device 110, which may be a smartphone, mobile phone, tablet computer, or other such device. The user may be prompted to provide personal information when communicating with the region classification server 104, and may elect not to provide such information. The region classification server 104 may be configured to anonymize the received user information upon receipt, and may remove the user information after a predetermined period of time.

As one example, user information may include such things as the name of the user, the age of the user, the ethnicity of the user, where the user lives or where the user is employed. The user information may also include the user's preferences for various goods or services. For instance, the user information may comprise restaurant preferences, such as preferred cuisine type(s), average price of a meal, atmosphere, seating capacity, and other restaurant preferences. In yet a further example, the personal user information may include real estate preferences, such as desired square footage, number of bedrooms, number of bathrooms, selling price, and other such real estate preferences.

The region classification server 104 may also be in communication with one or more systems 112-116 operative to receive classification(s) assigned to one or more regions. The systems 112-116 may include external and internal systems, where an internal system is a system that is owned by or affiliated with the owner and/or operator of the region classification server 104, and an external system is a system that is not owned by or affiliated with the owner and/or operator of the region classification server 104.

The systems 112-116 may be many different types of systems, receive different types of information from region classification server 104, and provide different types of services to the users of systems 112-116. For example, system 112 may be an Internet search provider server operative to receive region classification information from the region classification server 104 to provide more useful local search results to users. As another example, system 114 may be a real estate aggregator server operative to receive region classification information from the region classification server 104 to provide real estate listings for a region that matches a particular set of parameters, such as a region with a high density of ethnic restaurants. As yet another example, system 116 may be an augmented reality application server operative to receive region classification information to provide better modeled augmented reality applications at a local or regional level. Other types of services and systems 112-116 are, of course, possible.

The region classification server 104 may also be operative to format regional classification information based on the type of system requesting the regional classification information. For example, the region classification server 104 may provide a more detailed set of regional classification information to an internal system than it provides to an external system, or it may tailor the amount of information provided based on a subscription fee or other consideration.

FIG. 2 is one example of the region classification server 104. The region classification server 104 includes a memory 202 in communication with a processor 204. The memory 202 may be operative to store a region classification database 206, a classification type database 208, a classification evaluation database 210, and a user information database 212. While these databases are separately described, a person of skill in the art would understand that the databases can be combined into a single database, and can be distributed over one or more memories.

The region classification server 104 may also include a classifier 230 in communication with the processor 204 and the memory 202. In one embodiment, the classifier 230 can be a software module executed by the processor 204. As discussed below, the classifier 230 may be operative to classify a region. The region classification server 104 may further include one or more interfaces 222-228 to facilitate communication with one or more of the client devices 106-110 and/or the systems 112-116 shown in FIG. 1. In one embodiment, for example, interfaces 222-226 may communicate with client devices 106-110 and interface 228 may communicate with systems 112-116. Interface 222 may be configured to automatically receive regional information from client device 106, such as business listings, retailer listings, real estate listings, demographic information, combinations of the foregoing, or other regional information.

In one embodiment, user-input classification interfaces 224 and 226 may be operative to receive regional information or classifications from a user. User-input classification interfaces 224 and 226 may be Internet interfaces provided through a webpage or the like, interactive voice response (“IVR”) interfaces, or other such user interfaces, and may receive user input through various means, such as a checkbox, a radio button, a textbox, or a DTMF signal from a touchtone phone.

The classification type database 208 stores, as database records 216, a plurality of classification types and associated classification values. A classification type may be, for example, a business type (e.g., “restaurant,” “electronics retailer,” “clothing retailer”), a building type (e.g., “commercial,” “residential,” “industrial”), or a demographic type (e.g., “African-American,” “Caucasian,” or “Asian-American”). Other classification types are, of course, also possible.

Each of the classification types may be associated with one or more classification values. For example, the “restaurant” classification type may be associated with one or more cuisine values, such as “American,” “Chinese,” or “Japanese.” The “restaurant” classification type may also be associated with price values, which may be either qualitative (e.g., “expensive,” “inexpensive,” etc.), quantitative (e.g., “$25-$50,” “$50-$100,”), or combinations thereof. The “restaurant” classification type may further include classification values directed to the meal type (breakfast, lunch, dinner), portions of the meal (appetizer, entrée, etc.), a drink menu, or other restaurant characteristics.

As another example, the “electronics retailer” classification type may be associated with classification values such as the brands sold by the retailer, and the prices of those brands. As another example, the “residential” classification type may be associated with classification values describing the characteristics of a home, such as a selling price, number of bedrooms, number of bathrooms, and lot size. In general, the classification type database 208 may associate any number of classification types with any number of classification values.

The classification type database 208 may also support updates or modifications to the stored classification types and/or classification values. For example, when a user provides a classification for a region using the user-input classification interface 224, the region classification server 104 may determine whether a corresponding classification type and/or classification value is already included in the classification type database 208. In one embodiment, if it is not, the user may be prompted to add the provided classification type and/or classification value to the classification type database 208. In addition, when a user is prompted to provide a classification for a region via the user-input classification interface 224, the allowable types of classifications may be drawn from the classification type database 208.

The classification evaluation database 210 is operative to store a plurality of records (i.e., classification evaluation records 218) that can be used to determine a classification for a region. A classification evaluation record 218 may correspond to a classification type, and may include one or more thresholds that can be used to determine a classification value to assign to a region. For example, a classification evaluation record 218 may have a “restaurant” classification type, and may be used to determine whether a region should be classified with a restaurant-specific classification value. Thus, when region classification server 104 receives regional distribution information indicating that a region has a number or density of Indian restaurants above a threshold, that region may be classified as predominantly serving Indian cuisine. Similarly, if the region has a number or density of restaurants above a number threshold serving meals at or over a price threshold, the region may be classified as an “expensive” restaurant region.

In one embodiment, a classification evaluation record 218 may include a threshold, such as a predetermined number of restaurants serving a specific cuisine type (e.g., restaurants serving a cuisine type, 51% of restaurants serving a cuisine type, etc.) or a predetermined price point (e.g., $25, $50, $100, etc.), and the processor 204 may use the information contained in the classification evaluation record 218 to classify a region when at least some of the regional information values exceed this threshold. For example, when the classification evaluation record 218 includes a 50% cuisine type threshold and 51% of the restaurants in the region serve Indian food, the region may be classified as predominantly serving Indian cuisine.

Of course, a region may be classified with multiple classification values of the same or different classification types. For example, a region may be classified as having both “expensive” restaurants, and restaurants predominantly serving Indian cuisine. Similarly, a region may be classified as having fast food restaurants that serve predominantly American cuisine, and expensive restaurants that server predominantly French cuisine. Moreover, a region may be classified as having a predominance of fast food cuisine, where a majority serve American cuisine and a minority serve Mexican cuisine.

In general, a region may be assigned any number of classification types and associated classification values. For example, processor 204 may use information in classification evaluation database 210 to assign “restaurant” type classification values, as well as “electronics retailer” type classification values to a region. Thus, processor 204 may assign a region both with an “American cuisine” classification value and with an “expensive electronics retailers” classification value.

Moreover, processor 204 may classify a region by combining classification values associated with multiple classification types. For example, a region having high-end electronics retailers and expensive restaurants may be classified as a “high-end” region or an “expensive” region. As with the examples above, the classification of a region based on multiple classification values associated with multiple classification types may be determined from information such as thresholds obtained from the classification evaluation database 210.

In one embodiment, processor 204 may be operative to modify the classification evaluation records 218 and/or the thresholds stored therein based on received personal information. For example, a classification evaluation record 218 may include a threshold of “$100” to indicate that the processor 204 should classify restaurants serving meals over $100 as expensive. However, using received personal information, which may be stored in the personal information database 212 as one or more personal information records 220, processor 204 may modify the expensive restaurant threshold so that only restaurants serving meals over $200 are considered expensive for that user.

Another example may be instructive. Suppose the classification system determines a particular set of electronic brands to be desirable and a region having electronics retailers selling these brands to be a desirable region, e.g., a “good” region, a “region of interest,” or other classification value. The received personal information may modify this classification determination for a particular user who identifies those particular electronics brands to be not desirable. Hence, when the processor 204 classifies the region for that user based on the users received personal information, the region may be assigned a classification of “non-desirable,” “avoid,” “non-interesting” or other similar classification value. Accordingly, it is possible that a region be classified differently for different users based on the received personal information.

In addition to the classification evaluation database 210, the region classification server 104 may include a classifier 230 to classify the region according to one or more classification values from the classification type database 208. The classifier 230 may be a single type of classifier or a combination of classifiers. For example, the classifier 230 may be a linear classifier, a support vector machine, a quadratic classifier, a neural network, a Bayesian network, a hidden Markov model, any other type of classifier now known or later developed, or combinations thereof. In one embodiment, the classifier 230 may be given or programmed with a predetermined set of classified regions and may subsequently use this base knowledge to classify additional regions. The subsequently classified regions may be reviewed by a moderator and, when approved, may then be used by the classifier 230 to classify further additional regions. In some embodiments, a moderator may not review the assigned classifications by the classifier 230. Hence, the classifier 230 may be automatically learning and/or updating its knowledge base to classify regions.

In some implementations, the classifier 230 may reference the classification evaluation database 210 to classify a region. For example, there may be instances where the classifier 230 may be able to classify a region with two possible classification values. While the classifier 230 may assign both of the classification values to the region, the classifier 230 may also reference the classification evaluation database 210, which may indicate a preference for one of the two possible classifications. Although the classifier 230 is shown within the region classification server 104, it should be understood that the classifier 230 may also be external to the region classification server 104 and in communication with the region classification server 104 via one or more networks, such as network 120.

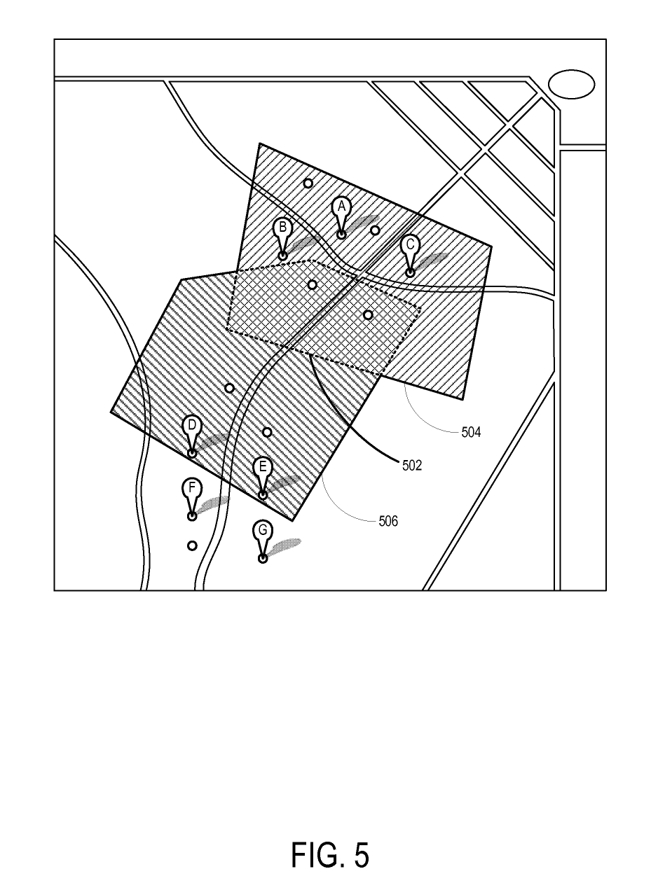

The region classification database 206 is operative to store a plurality of regional classifications, wherein each regional classification comprises at least one classification value assigned to a region. The region classification database 206 may include one or more region classification records 214 that correspond to the regional classifications. As discussed above, a region may be assigned multiple classification values. In addition, where regions overlap or intersect (as shown in FIG. 5, discussed below), the overlapping or intersecting portions of the regions may be assigned multiple classification values. Hence, it is possible that one portion of a region is assigned a first set of classification values and that a second portion of the region is assigned a second set of classification values, where the second set of classification values include the first set of classification values as well as additional classification values assigned to an adjacent region.

The region classification request interface 228 is operative to receive a request for one or more regional classifications stored in the region classification database 206. The request for the one or more regional classifications may originate with one or more different types of entities, such as the systems 112-116 shown in FIG. 1. In one embodiment, the processor 204 is operative to retrieve the requested regional classifications stored in the region classification database 206, format a response to the request based on the type of requesting entity, and then transmit the formatted response to the requesting entity.

In one embodiment, formatting the response may include modifying the response and/or the regional classification based on the type of requesting entity. For example, as mentioned above, some entities requesting the classification assignments may be internal entities and some entities may be external entities. In some implementations, internal entities may receive a more complete set of regional classification assignments than entities that are external to the region classification server 104. Similarly, where the region classification server 104 has a pricing structure for various granularities of regional information, the requesting entity may receive a set of regional classification assignments that depends on the price it is willing to pay for that information. Thus, an entity paying a higher price may receive a set of regional classification assignments at a finer granularity than a requesting entity paying a lower price.

In addition, the processor 204 may format a response to the requesting entity based on the entity's line of business. For example, a first requesting entity, such as a multiple listing service, may require the regional classification information be in one format whereas a second requesting entity, such as an augmented reality developer, may require the regional classification information to be in a different format. In an alternative embodiment, the region classification server 104 may implement a protocol for providing the regional classification assignments, and the requesting entities may request the regional classification assignments according to the implemented protocol.

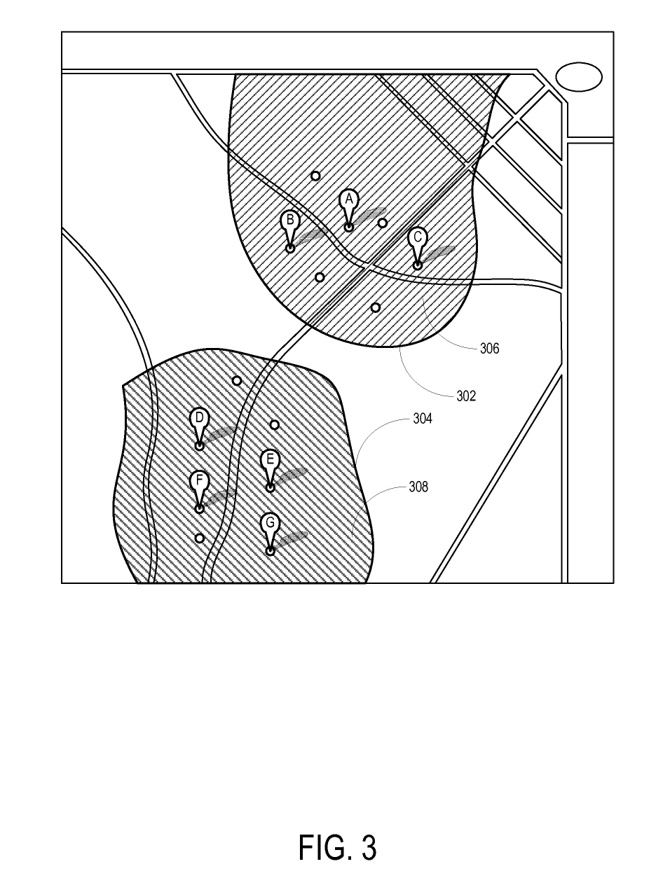

FIG. 3 illustrates one example of regions being classified according to aspects of the invention. As shown in FIG. 3, a first region 302 has been assigned a first classification 306 and a second region 304 has been assigned a second classification 308. One or more postal identifiers, such as a zip code, city name, neighborhood name, or other identifier, may identify the first region 302 and/or the second region 304. Furthermore, the first region 302 may have been assigned the first classification 306 based on one or more locations within the first region 302, such as locations A-C. Similarly, the second region 304 may have been assigned the second classification 308 based on one or more locations within the second region, such as locations D-G. It should be understood that, while FIG. 3 represents an illustration of the classifications 306-308 assigned to the regions 302-304, a requesting entity may request the regional classifications via the region classification request interface 228 shown in FIG. 2.

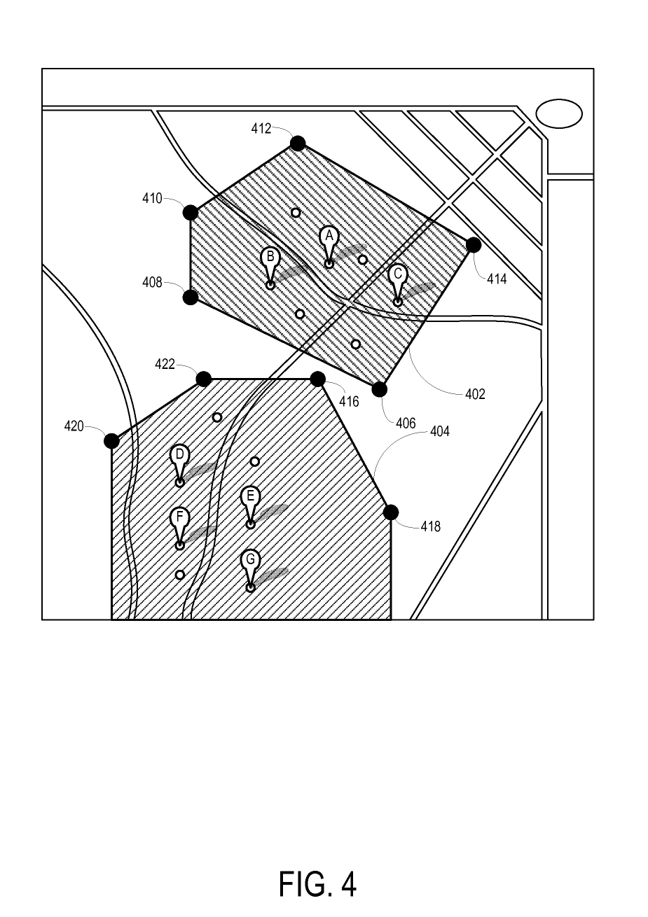

FIG. 4 illustrates one example of user-defined regions being classified according to aspects of the invention. As shown in FIG. 4, a first user-defined region 402 may be identified by one or more parameters, such as coordinates 406-414. Similarly, a second user-defined region 404 may be also be identified by one or more parameters, such as coordinates 416-422. Coordinates 406-422 may be any type of coordinates, such as absolute geographic coordinates (e.g., latitude and longitude), or Cartesian coordinates on a map displayed to the user.

The user-defined regions 402-404 may have been defined by a user communicating with the region classification server 104 via the user-input classification interface 224. In addition, the user may have classified the user-defined regions 402-404 using the user-input classification interface 224. In another embodiment, region classification server 104 may have classified these user-defined regions using region classifier 230. In yet a further embodiment, the region classification server 104 may assign a temporary classification to the user-defined regions 402-404, and then confirm with the user that the temporary classifications should be assigned to the user-defined regions 402-404. Combinations of the foregoing embodiments are also possible. It should be understood that while FIG. 4 represents an illustration of the classifications assigned to the user-defined regions 402-404, a requesting entity may request the regional classifications via the region classification request interface 228 shown in FIG. 2.

FIG. 5 illustrates one example of an overlapping region being classified according to aspects of the invention. As shown, an overlapping region 502 may include a portion of a first region 504 and a second region 506. The first region 504 may be assigned one or more classification values and the second region 506 may also be assigned one or more classification values, which may be different than the classification values assigned to the first region 504. As shown in FIG. 5, the overlapping region 502 may be assigned classification values that include classification values assigned to the first region 504 and classification values assigned to the second region 506. In instances where regions overlap, the region classification server 104 may update or modify the region classification database 206 to reflect that a third region (overlapping region 502) exists and may assign the classification values assigned to the first and second regions 504 and 506 to this third region. It should be understood that while FIG. 5 represents an illustration of the classifications assigned to the overlapping region 502, a requesting entity may request the regional classifications for the regions 502-506 via the region classification request interface 228 shown in FIG. 2.

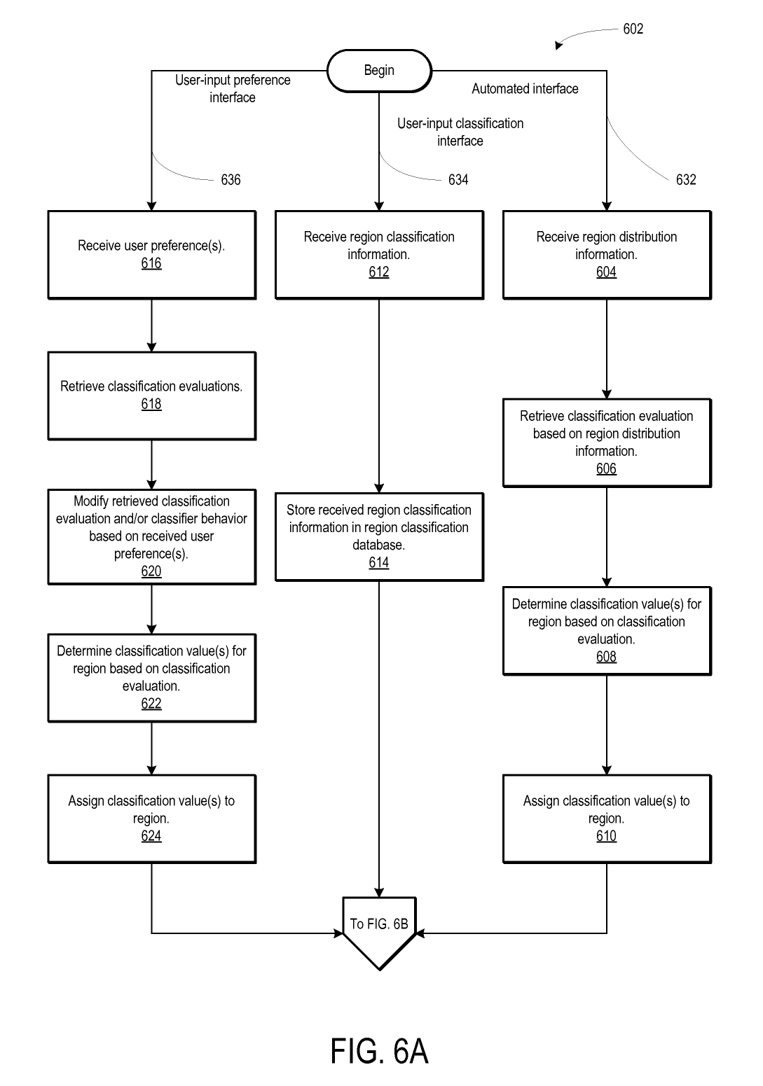

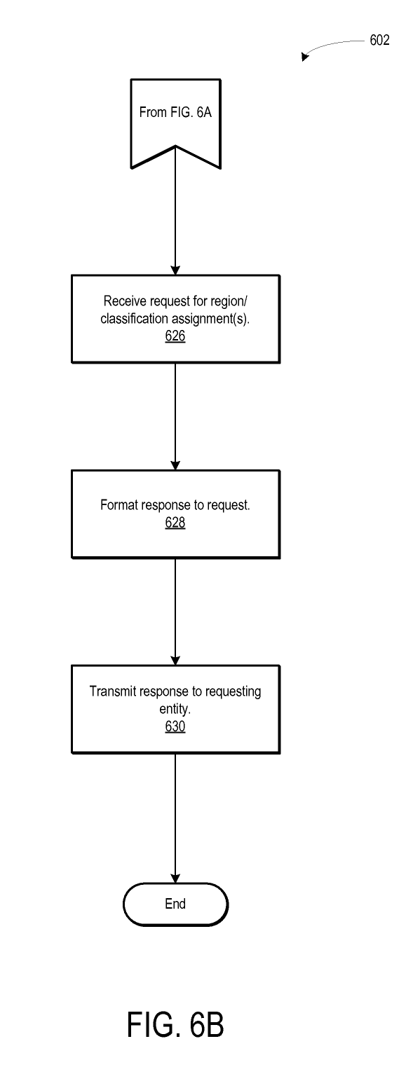

FIG. 6A illustrates one example of logic flow 602 for classifying a region and transmitting the assigned classification according to aspects of the invention. Logic flow 602 may have three branches 632, 634, and 636 for proceeding depending on which interface (the automated interface 222, the user-input classification interface 224, or the user-input information interface 226) receives information from the one or more client devices 106-110.

Starting with branch 632, the automated interface 222 may receive regional distribution information from one or more client devices, such as the client device 106 (Block 604). The processor 204 may then retrieve one or more classification evaluation records 218 from the classification evaluation database 210 to evaluate the region distribution information (Block 606). Thereafter, the processor 204 may determine one or more classification value(s) for the region based on the retrieved one or more classification evaluation records and the received region distribution information (Block 608). Alternatively, the classifier 230 may determine one or more classification values based on the received regional distribution information alone. The processor 204 may then assign the determined one or more classification values to the one or more regions corresponding to the region distribution information and store the classification values in the region classification database 206 (Block 610).

Next, with branch 634, the user-input classification interface 224 may receive personal information about a user for assigning classification values to one or more regions (Block 612). As discussed above, the processor 204 may store the received user-input classifications in the region classification database 206 (Block 614).

Turning to branch 636, the user-input information interface 226 may receive personal information about a user that the region classification server 104 uses to classify or alter the classification of one or more regions. Initially, the user-input information interface 226 receives the personal information (Block 616). Thereafter, the processor 204 may retrieve one or more classification evaluations to evaluate one or more regions based on the received personal information (Block 618). In one embodiment, the processor 204 may modify one or more of the classification evaluations based on the received personal information (Block 620), and determine one or more classification values for one or more regions based on the modified classification evaluations (Block 622). In another embodiment, the personal information may modify the behavior and/or determinations made by the classifier 230. The processor 204 may then assign the determined classification values to the one or more regions, such as by storing a region assignment comprising the determined one or more classification values in the region classification database 206 (Block 624).

FIG. 6B continues the logic flow 602 from FIG. 6A. Here, the region classification request interface 228 may receive a request for one or more regional classifications stored in the region classification database 206 (Block 626). As previously discussed, the request for the one or more regional classifications may originate with one or more different types of entities, such as the systems 112-116 shown in FIG. 1.

The processor 204 formats a response to the request for the one or more region assignments (Block 628). As discussed above, formatting the response may include modifying the response and/or the regional classification based on the type of requesting entity, the entity's line of business, or other factors. The processor 204 may then transmit the formatted response to the requesting entity, where the response comprises the requested one or more regional classifications (Block 630). The response to the request for the one or more regional classifications may be transmitted via the regional classification request interface 228.

In this manner, the region classification server 104 facilitates an expeditious classification of one or more regions based on information provided from various sources. By leveraging the classification evaluations and/or the classifier, the region classification server 104 may intelligently assign various classifications to one or more regions. As noted above, the region classification server 104 may receive user information that is personal. Users may in general elect not to provide personalized user information, in which case the region classification server 104 may not be able to personalize the regional classifications to the interests of a particular user. When users do provide personal information, the region classification server 104 may be configured to anonymize the received user information and/or to remove the user information after a predetermined period of time.

The region classification server 104 may provide the regional classifications to other systems, such that other systems may provide their users with the determined region classification assignments. Hence, the region classification server 104 may provide a middleware solution that enhances the user's experience through custom-tailoring of region classification assignments and the region classification server 104 may enhance the services and information offered by other systems.

The region classification server 104 described above may be implemented in a single system or partitioned across multiple systems. In addition, the memory 202 may be distributed across many different types of computer-readable media. The memory 202 may include random access memory (“RAM”), read-only memory (“ROM”), hard disks, floppy disks, CD-ROMs, flash memory or other types of computer memory.

Databases 206-212, interfaces 222-228, and classifier 230 may be implemented in a combination of software and hardware. For example, classifier 230 may be implemented as a set of instructions written in a computer programming language, such as C# or Java, or any other computer programming language now known or later developed. The classifier 230 may also be implemented in a computer scripting language, such as JavaScript, PHP, ASP, or any other computer scripting language now known or later developed. Furthermore, the classifier 230 may be implemented using a combination of computer programming languages and computer scripting languages.

In addition, the region classification server 104 may be implemented with additional, different, or fewer components. As one example, the processor 204 and any other logic or component may be implemented with a microprocessor, a microcontroller, a DSP, an application specific integrated circuit (ASIC), discrete analog or digital circuitry, or a combination of other types of circuits or logic. The databases 206-212, interfaces 222-228, and classifier 230 may be distributed among multiple components, such as among multiple processors and memories, optionally including multiple distributed processing systems.

Logic, such as programs, may be combined or split among one or more programs, distributed across several memories and processors, and may be implemented in or as a functional library, such as a dynamic link library (DLL) or other shared library. The DLL, for example, may store code that implements functionality for a specific module as noted above. As another example, the DLL may itself provide all or some of the functionality of the system.

The databases 206-212 may be stored as a collection of data. For instance, although the databases 206-212 are not limited by any particular data structure, the databases 206-212 may be stored in computer registers, as relational databases, flat files, or any other type of database or data repository now known or later developed.

Networks 118-120 may be implemented as any combination of networks. As examples, the networks 118-120 may be a Wide Area Network (“WAN”), such as the Internet; a Local Area Network (“LAN”); a Personal Area Network (“PAN”), or a combination of WANs, LANs, and PANs. Moreover, the networks 118-120 may involve the use of one or more wired protocols, such as the Simple Object Access Protocol (“SOAP”); wireless protocols, such as 802.11a/b/g/n, Bluetooth, or WiMAX; transport protocols, such as TCP or UDP; an Internet layer protocol, such as IP; application-level protocols, such as HTTP, a combination of any of the aforementioned protocols, or any other type of network protocol now known or later developed.

Interfaces between and within the region classification server 104, such as interfaces 222-228 may be implemented using one or more interfaces, such as Web Services, SOAP, or Enterprise Service Bus interfaces. Other examples of interfaces include message passing, such as publish/subscribe messaging, shared memory, and remote procedure calls.

Although aspects of the invention herein have been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the invention as defined by the appended claims. Furthermore, while certain operations and functions are shown in a specific order, they may be performed in a different order unless it is expressly stated otherwise.

1. An apparatus for classifying a region based on distribution information, the apparatus comprising:
a memory operative to store:
a plurality of associations between a plurality of classification types and a plurality of classification values for the region, wherein each classification type is associated with at least one classification value, the at least one classification value identifying characteristics of the corresponding classification type;
a plurality of classification evaluations for assigning a classification to the region, wherein each classification evaluation is associated with a classification type; and
a processor in communication with the memory, the processor being operative to:
receive regional distribution data for the region;
determine at least one classification type selected from the plurality of classification types based on the received regional distribution data;
select at least one classification evaluation for the region based on the determined at least one classification type;
determine a classification value for the at least one region assignment based on the at least one classification evaluation and the regional distribution data;
store at least one region assignment for the region in a region classification database, the at least one region assignment comprising an association between the least one determined classification value and the region;
receive a request for a region assignment from a requesting entity;
determine, based on the request, a type of the requesting entity;
format a response to the request based on the type of requesting entity; and
transmit the formatted response to the requesting entity.

2. The apparatus of claim 1, wherein the region is defined by a plurality of coordinates.

3. The apparatus of claim 1, wherein the region is identified according to a postal address identifier.

4. The apparatus of claim 1, wherein the at least one classification evaluation comprises a threshold and the processor determines the classification value for the at least one region assignment when the at least one classification value for the at least one classification type obtained from the region distribution data exceeds the threshold.

5. The apparatus of claim 1, wherein the at least one classification evaluation comprises a first threshold associated with a first classification value and a second threshold associated with a second classification value; and
the processor is further operative to:
determine the classification value for the at least one region assignment based on the relationship between the first classification value and the first threshold and the second classification value and the second threshold.

6. The apparatus of claim 1, wherein the classification value for the at least one region assignment is associated with a first classification type; and
the processor is further operative to determine a second classification value for a second region assignment based on the evaluation of at least a second classification value associated with a second classification type and evaluated by a second classification valuation, the first classification type and the second classification type being different types of classifications.

7. The apparatus of claim 1, wherein:
the apparatus further comprises an automated business listing information interface operative to receive a plurality of business listings located in the region;
the received regional distribution data comprises the plurality of received business listings; and
the processor determines, for each of the plurality of business listings, the classification type selected from the plurality of classification types based on a business type associated with each of the plurality of business listings.

8. The apparatus of claim 1, wherein:
the apparatus further comprises a user-input classification interface operative to receive a region assignment from a user; and
the processor is further operative to store the received region assignment from the user in the region classification database.

9. The apparatus of claim 1, wherein:
the apparatus further comprises a user-input information interface operative to receive user information; and
the processor is further operative to modify the at least one classification evaluation based on the received user information.

10. (canceled)

11. A method for classifying a region based on distribution information, the method comprising:
establishing, in a memory, a plurality of associations between a plurality of classification types and a plurality of classification values, wherein each classification type is associated with at least one classification value, the at least one classification value identifying characteristics of the corresponding classification type;
establishing a plurality of classification evaluations for assigning a classification to the region;
receiving, with at least one processor in communication with the memory, regional distribution data for the region;
determining, with the at least one processor, at least one classification type selected from the plurality of classification types based on the received regional distribution data;
determining, with the at least one processor, at least one classification evaluation for the region based on the at least one classification type;
determining, with the at least one processor, at least one classification value for the at least one region assignment based on the at least one classification evaluation and the regional distribution data;
storing, with the at least one processor, at least one region assignment for the region in a region classification database, the region assignment comprising an association between the determined at least one classification value and the region;
receiving, with the at least one processor, a request from a requesting entity for a region assignment;
determining, with the at least one processor and based on the request, a type of requesting entity;
formatting, with the at least one processor, a response to the request based on the type of requesting entity; and
transmitting, with the at least one processor, the formatted response to the requesting entity.

12. The method of claim 11, wherein the region is defined by a plurality of coordinates.

13. The method of claim 11, wherein the region is identified according to a postal address identifier.

14. The method of claim 11, wherein the at least one classification evaluation comprises a threshold and the method further comprises determining the classification value for the at least one region assignment when the at least one classification value for the at least one classification type obtained from the region distribution data exceeds the threshold.

15. The method of claim 11, wherein the at least one classification evaluation comprises a first threshold associated with a first classification value and a second threshold associated with a second classification value; and
the method further comprises:
determining the classification value for the at least one region assignment based on the relationship between the first classification value and the first threshold and the second classification value and the second threshold.

16. The method of claim 11, wherein the classification value for the at least one region assignment is associated with a first classification type; and
the method further comprises determining a second classification value for a second region assignment based on the evaluation of at least a second classification value associated with a second classification type and evaluated by a second classification evaluation, the first classification type and the second classification type being different types of classifications.

17. The method of claim 11, further comprising:
receiving a plurality of business listings located in the region, wherein the received regional distribution data comprises the plurality of business listings; and
determining, for each of the plurality of business listings, the classification type selected from the plurality of classification types based on a business type associated with each of the plurality of business listings.

18. The method of claim 11, further comprising:
receiving a region assignment from a user; and
storing the received region assignment from the user in the region classification database.

19. The method of claim 11, further comprising:
receiving user information; and
modifying the at least one classification evaluation based on the received user information.

20. (canceled)
